(19) United States
(12) Patent Application Publication
(10) Pub. No.: US 2025/0323894 A1
(43) Pub. Date: Oct. 16, 2025

(54) CONTENT INSPECTION USING HTTP EXPECT-100

(71) Applicant: Cisco Technology, Inc., San Jose, CA (US)

(72) Inventors: Pak Ho Philip Kwok, London (GB); Raluca Lungociu, San Jose, CA (US)

(21) Appl. No.: 18/956,563

(22) Filed: Nov. 22, 2024

Related U.S. Application Data
(60) Provisional application No. 63/634,188, filed on Apr. 15, 2024.

(51) Int. Cl. H04L 9/40

(52) U.S. Cl. CPC H04L 63/0236; H04L 63/0281; H04L 63/1416

(57) ABSTRACT

In one aspect, a method for data loss prevention (DLP) scanning in a network environment includes receiving a request from a proxy in the network environment. This request seeks permission from the server to send content for DLP scanning. The method involves performing a policy evaluation at the DLP scanner using the information extracted from the HTTP headers to determine if the content matches a DLP policy and should undergo scanning. If the content requires scanning, an HTTP response “100 continue” is sent from the DLP scanner to the proxy. Upon receiving this response, the content is sent from the proxy for scanning. The DLP scanner processes the content to identify policy violations, and if the scan is successful and the content is not in violation, it is forwarded to the intended destination within the network environment when the content is not in violation of the DLP policy.

### CROSS-REFERENCE TO RELATED APPLICATIONS

This application claims priority to U.S. provisional application No. 63/634,188, filed on Apr. 15, 2024, which is expressly incorporated by reference herein in its entirety.

### FIELD OF THE TECHNOLOGY

The field of technology for this patent application relates to a method for data loss prevention (DLP) scanning in a network environment.

### BACKGROUND

Data loss prevention (DLP) is an important part of modern enterprise data security strategies, and is crucial for safeguarding sensitive information and mitigating potential risks. In an era marked by increasingly sophisticated cyber threats and stringent regulatory requirements, enterprises face mounting pressure to protect their data assets from unauthorized access, sharing, or leakage. DLP solutions play a pivotal role in this regard, offering an approach to identifying, monitoring, and controlling data flows across the network. By employing advanced detection mechanisms and policy enforcement capabilities, DLP network appliances empower enterprises to identify and classify sensitive data, monitor its movement within the network, and enforce granular access controls and encryption protocols. This helps prevent data breaches and compliance violations and mitigates the risks associated with insider threats and inadvertent data exposure. The strategic deployment of DLP solutions enables enterprises to bolster their resilience against data loss incidents, safeguard their reputation, and maintain the trust of customers and stakeholders in an increasingly data-driven business landscape.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings, and the claims.

FIG. 1 illustrates an example communication diagram for a proxy and DP scanner according to some aspects of the present technology.

FIG. 2 illustrates a process for data loss prevention (DLP) scanning in a network environment according to some aspects of the present technology.

FIG. 3 illustrates an example of a computing system according to some aspects of the present disclosure.

### DETAILED DESCRIPTION

Various examples of the disclosure are discussed in detail below. While specific implementations are discussed, it should be understood that this is done for illustration purposes. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an example in the present disclosure can be references to the same example or any example, and such references mean at least one of the examples.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative, and is not intended to further limit the scope and meaning of the disclosure or of any example term. Likewise, the disclosure is not limited to various embodiments given in this specification.

Additional features and advantages of the disclosure will be set forth in the description that follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### OVERVIEW

In the realm of real-time inline Data Loss Prevention (DLP), enterprises often implement a defense mechanism where customer web traffic traverses through a designated proxy infrastructure for scrutiny by a DLP inspection scanner. The DLP scanner ensures that every piece of data flowing in and out of the network undergoes examination, allowing for immediate detection and prevention of potential data breaches or policy violations. The proxy serves as a gateway, intercepting web requests and responses, while the DLP inspection scanner analyzes the content, structure, and context of the data packets in transit. The DLP scanner uses signature-based detection, pattern matching, and machine learning algorithms to identify sensitive information such as personally identifiable information (PII), financial data, or confidential documents. Upon detection of any unauthorized or suspicious data, the DLP system can determine whether mitigation acts should be taken to address content received, including notifying the proxy of a determination causing the network security system to block the transmission, encrypt the data, or trigger alerts to security administrators for further investigation.

In one aspect, the techniques described herein relate to a method for data loss prevention (DLP) scanning in a network environment, including: receiving a request from a proxy in the network environment, wherein the request is to ask permission from a server to send content associated with the request for DLP scanning, the request includes HTTP headers and the content for DLP scanning that are transmitted in a body of the request that are associated with a communication; performing a policy evaluation at a DLP scanner using information extracted from the HTTP headers included in the request to determine whether the content matches a DLP policy and should undergo scanning; upon determining the content is to undergo scanning in accordance with the DLP policy, sending an HTTP response “100 continue” from the DLP scanner to the proxy; in response to the HTTP response, receiving the content associated with the request from the proxy for scanning; processing the content scanned at the DLP scanner to identify policy violations; and in response to processing of the content being successful and not in violation of the DLP policy, forwarding the content scanned to an intended destination within the network environment.

In some aspects, the techniques described herein relate to a method, further including upon determining the content does not necessitate scanning, replying with an HTTP response “200 OK” from the DLP scanner to the proxy, indicating that no scan of the content is required.

In some aspects, the techniques described herein relate to a method, further including receiving the DLP policy at the DLP scanner from an S3 bucket.

In some aspects, the techniques described herein relate to a method, wherein receiving the DLP policy at the DLP scanner includes configuring the DLP policy via a secure access dashboard associated with the network environment by a network administrator, wherein the DLP policy configured is stored in a database; and pushing the DLP policy configured to the DLP scanner from the database.

In some aspects, the techniques described herein relate to a method, wherein the HTTP headers in the body of the request includes metadata specifying an identity of a sender and a destination of the content.

In some aspects, the techniques described herein relate to a method, wherein processing the content scanned at the DLP scanner to identify policy violations includes: identifying one or more data leak policies in the DLP policy, the one or more data leak policies configured to assist the DLP scanner with determining whether the content matches a DLP policy; identifying a sender of the content scanned as a member of a specific department based on the information extracted from the HTTP headers; determining a destination of the content from the information extracted from the HTTP headers, wherein the destination of the content includes a network application; matching the information associated with the sender and destination against the one or more data leak policies to identify whether the content requires scanning; and in response to determining that an identification of the sender and the destination matches the network application specified in the one or more data leak policies, performing a scan of the content to check for personal identifying information (PII) or restricted information in violation of the DLP policy.

In some aspects, the techniques described herein relate to a method, wherein the HTTP headers are populated by the proxy, the proxy configured to: populate the HTTP headers with identification information of a sender of the request, including location, department, or role, based on information imported from an active directory; and populate the HTTP headers with destination information related to a destination to which the sender intends to transmit the content.

In one aspect, the techniques described herein relate to a network device including: one or more memories having computer-readable instructions stored therein; and one or more processors configured to execute the computer-readable instructions to: receive a request from a proxy in a network environment, wherein the request is to ask permission from a server to send content associated with the request for DLP scanning, the request includes HTTP headers and the content for DLP scanning that are transmitted in a body of the request associated with a communication; perform a policy evaluation at a DLP scanner using information extracted from the HTTP headers included in the request to determine whether the content matches a DLP policy and should undergo scanning; upon determining the content is to undergo scanning in accordance with the DLP policy, send an HTTP response “100 continue” from the DLP scanner to the proxy; in response to the HTTP response, receive the content associated with the request from the proxy for scanning; process the content scanned at the DLP scanner to identify policy violations; and in response to processing of the content being successful and not in violation of the DLP policy, forward the content scanned to an intended destination within the network environment.

In one aspect, the techniques described herein relate to a non-transitory computer-readable storage medium including computer-readable instructions, which when executed by one or more processors of a network appliance, cause the network appliance to: receiving a request from a proxy in a network environment, wherein the request is to ask permission from a server to send content associated with the request for DLP scanning, the request includes HTTP headers that are transmitted in a body of the request, the body of the request comprising the content for DLP scanning; performing a policy evaluation at a DLP scanner using information extracted from the HTTP headers included in the request to determine whether the content matches a DLP policy and should undergo scanning; upon determining the content is to undergo scanning in accordance with the DLP policy, sending an HTTP response “100 continue” from the DLP scanner to the proxy; in response to the HTTP response, receiving the content associated with the request from the proxy for scanning; processing the content scanned at the DLP scanner to identify policy violations; and in response to processing of the content being successful and not in violation of the DLP policy, forwarding the content scanned to an intended destination within the network environment.

### EXAMPLE EMBODIMENTS

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

In real-time inline Data Loss Prevention (DLP), customer web traffic undergoes a thorough examination by a DLP inspection scanner after passing through a designated proxy. Within modern microservices architectures, proxies and DLP scanners are often distinct microservices situated on separate hosts within a data center.

Consequently, when the proxy forwards content to the DLP scanner for scanning, the content typically traverses from one host to another, potentially incurring network latency, particularly if the content is substantial. Prior to initiating the scanning process, the DLP scanner conducts a policy evaluation to determine whether the content necessitates scanning. If the request fails to align with any predefined policies, the content is omitted from scanning. Nonetheless, the content is still transmitted over the network to the scanner during the HTTP request. Essentially, the proxy transfers the content without assessing the necessity of its transmission, leading to the utilization of superfluous bandwidth and inefficiencies stemming from network latency.

Typically, the process involves sending the content along with a set of metadata. Using this metadata, policies are evaluated to determine whether any of the policies apply to the content. If any policies apply, the content is scanned according to the policy. However, an inefficiency arises when the size of the content is substantial, resulting in wasted bandwidth and time spent sending content that might not need to be scanned by the DLP. Transmitting large content takes time, and often the content does not require scanning. Thus, the time and bandwidth spent sending content from one service to another are wasted.

The HTTP expect-100 protocol and specifically the HTTP expect-100 header is a mechanism that is utilized to avoid the transfer of content for requests that do not match certain configuration policies. The Expect: 100-continue header in HTTP allows a client to ask the server for permission before sending a large request body. When a client includes this header in its initial request, it requests the server to confirm if it should proceed with sending the request body. The server responds with a “100 Continue” status code if it is willing to accept the body, or it may respond with an error status code if it does not want the body.

Examples of the HTTP expect-100 protocol can include, for example, the upload of large files, a client can send a request with the HTTP expect-100 continue header before uploading the file. This prevents the client from sending a large amount of data if the server is not ready to accept it or if there are issues with the request. In terms of bandwidth optimization, the use of Expect: 100-continue allows a client to save bandwidth and resources. If the server rejects the request based on headers alone, the client avoids wasting time and bandwidth on a potentially large payload. For error handling, it helps manage errors efficiently. If the client sends a large request body that the server rejects, the client can avoid the effort and bandwidth required to send the body by first checking if the server will accept it.

However, the current DLP technologies do not provide the ability to utilize HTTP except-100 protocol. Current DLP technologies do not use the HTTP Expect-100 protocol because it is not suited for DLP purposes. The HTTP Expect-100 protocol is primarily used to verify if the request header contains enough information to generate a response before the body is transmitted. However, DLP technologies typically require a different approach during policy evaluations, as examining header information typically is insufficient to determine whether a policy applies or to resolve a response related to data loss prevention.

The disclosed technology provides a solution to the above challenges by introducing a method for optimizing data transfer during Data Loss Prevention (DLP) processes by using the HTTP Expect-100-continue header. This method allows for a single request containing information for policy evaluation to be sent to a DLP scanner. The scanner then performs the evaluation and decides whether further action is required. Thus, the HTTP Expect-100 protocol is leveraged to identify requests and determine applicable policies, thus avoiding unnecessary data transfer.

The disclosed technology can perform policy evaluations by a DLP scanner that first receives metadata sent through HTTP headers by a proxy. The DLP scanner examines these HTTP headers to perform the policy evaluation without transmitting the actual content. If the evaluation indicates that scanning is unnecessary, the content is not sent, conserving bandwidth, and reducing latency.

Typically, the content in question includes data uploaded by customers to the internet or downloaded from private internal applications. The content can also encompass data transmitted internally, often containing private information such as Personally Identifiable Information (PII). In some examples, when the content includes PII or other restricted information designated by the policy, the DLP scanner performs a detailed analysis to determine whether the information identified violates any DLP policy. The scanner examines the content for specific types of data that the policies are designed to protect, such as social security numbers, credit card details, health records, or any other sensitive data defined by the organization's DLP rules.

For instance, if a policy dictates that any document containing PII is not to be uploaded to an external cloud storage service, the DLP scanner will scrutinize the content for characteristics that match PII definitions. If the DLP scanner identifies any such information, the DLP scanner will flag the content as a policy violation. The scanner's evaluation process involves using predefined rules and algorithms to detect the presence of sensitive data, ensuring that the organization's data protection requirements are met. This helps prevent unauthorized access, data breaches, and potential compliance issues by ensuring that restricted information is handled according to the established policies. Prior to such inspection, the HTTP header sent to the DLP scanner can include information that includes identification information about the source, the intended action to be performed with the content being transmitted, and the destination of the content which can be used to determine if the content is a type of content that should be scanned for PII according to the DLP rules. The DLP scanner uses this information to determine the need for scanning by comparing the information to content scanning policies.

Customers create custom DLP policies using a secure access dashboard. These policies are stored in a database and downloaded by scanners from an S3 bucket. For example, a DLP policy might indicate that scanning for credit card numbers in uploads to Dropbox from the finance department. When such a request is received, the headers are checked for a match with the policy. If a match is found, the content is scanned. Conversely, if a request from the legal department does not match the policy, the content is not sent for scanning, saving time and resources.

The disclosed technology efficiently utilizes resources by consolidating policy evaluation and content transfer into a single HTTP transaction, eliminating the need for separate calls. This optimization is particularly beneficial when dealing with large files, as it prevents unnecessary data transfer if the content does not require scanning. By incorporating the Expect 100-continue header, the protocol ensures that permissible content that is not in violation of the DLP policy is transmitted, thereby enhancing the overall efficiency of the DLP scanner policy evaluation.

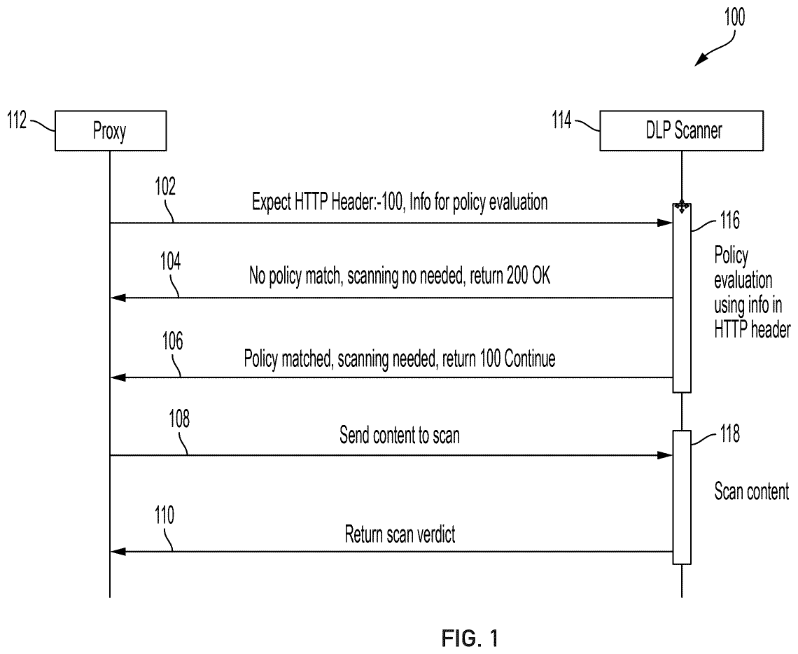

FIG. 1 illustrates an example communication diagram 100 for a proxy 112 and DLP scanner 114 according to some aspects of the present technology. The proxy 112 and DLP scanner 114 are configured to communicate with each other to monitor and control data flow in a network environment such as an enterprise network environment. Proxy 112 can serve as an intermediary between the user and the internet or the network environment. Proxy 112 is positioned near the network environment perimeter or a gateway of the network environment, where proxy 112 can intercept all outbound and inbound traffic, such as web requests, responses, emails, and file transfers, to enforce security policies.

DLP scanner 114, either integrated with proxy 112 or operating alongside proxy 112, can analyze the content of the data passing through proxy 112. DLP scanner 114 can inspect this content in real-time to detect any sensitive information that may violate the organization's data protection policies. Based on predefined DLP rules, the scanner determines whether to allow, block, or flag the data, ensuring compliance and to determine whether there is a violation of the policy. Further examples are provided in the below discussion of communication diagram 100.

The proxy 112 can receive a request from a sender that includes content to be transmitted to an intended destination. Upon receiving this request, proxy 112 can identify the user associated with the request by accessing an active directory associated with the network environment. This active directory provides identification information related to the user, such as their role, department, location, or permissions. Using this information, proxy 112 populates additional HTTP headers with the identification information of the sender.

Additionally, proxy 112 populates the additional HTTP headers with destination information, indicating where the sender intends to transmit the content. This ensures that upon transmission of the additional HTTP headers to DLP scanner 114, DLP scanner 114 receives metadata in the additional HTTP headers to evaluate the request, and to perform a policy evaluation.

In step 102, proxy 112 sends the additional HTTP headers to DLP scanner 114. Upon receiving the additional HTTP headers from proxy 112, DLP scanner 114 performs a policy evaluation 116 to decide whether the content needs to be scanned. Policy evaluation 116 is based on policy-identifying information, including the identification and destination information provided in one or more of the additional HTTP headers.

In step 104, if DLP scanner 114 determines that there is no policy match associated with the policy identifying information, DLP scanner 114 responds to proxy 112, indicating that the content does not need to be scanned. Subsequently, DLP scanner 114 transmits a “200 OK” response to proxy 112, signaling that no scan is required. As a result, no content will be sent to DLP scanner 114 for scanning.

In step 106, if the content should be scanned, DLP scanner 114 sends an HTTP “100 Continue” response to proxy 112, indicating that the content associated with the request is to be scanned.

In step 108, in response to the HTTP “100 Continue” received from DLP scanner 114, proxy 112 sends the content to DLP scanner 114 to perform scanning of the content 118, continuing the request from step 102.

During scanning of the content 118, DLP scanner 114 can identify a match between the sender identification information or destination information in the HTTP header and the parameters defined in the DLP policy. For instance, if an employee in the finance department attempts to upload a file to the external cloud storage service, DROPBOX, DLP scanner 114 uses the HTTP header to verify the sender's department and the destination. The DLP policy may stipulate that any uploads from the finance department to external cloud services, such as DROPBOX, is to be scanned for sensitive information like credit card numbers or financial data. Upon identifying this match, DLP scanner 114 applies the relevant data leak policies to thoroughly inspect the content for any restricted information, ensuring compliance with the organization's data protection protocols.

In step 110, DLP scanner 114 returns a scan verdict to proxy 112, providing the results of the content scanning. The verdict indicates whether a policy violation has occurred. For example, a policy violation may occur when the content includes PII, or data specified in the policy as restricted or non-permissive. Thus, proxy 112 is notified that the content is not allowed to be transmitted by the sender or by the proxy due to one or more conditions outlined in the DLP policy.

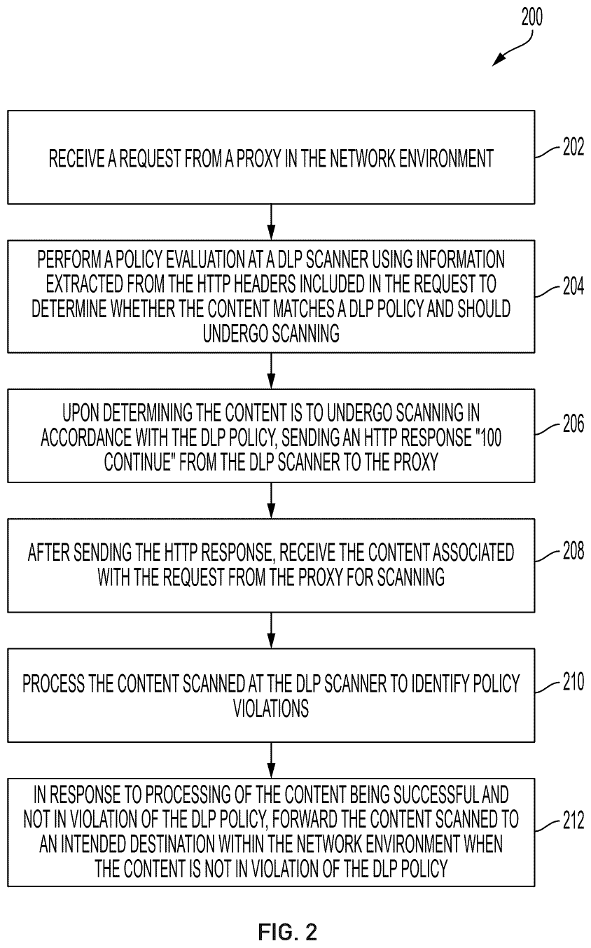

FIG. 2 illustrates a process for data loss prevention (DLP) scanning in a network environment according to some aspects of the present technology. Although the example process 200 depicts a particular sequence of operations, the sequence may be altered without departing from the scope of the present disclosure. For example, some of the operations depicted may be performed in parallel or in a different sequence that does not materially affect the function of the process 200. In other examples, different components of an example device or system that implements the process 200 may perform functions at substantially the same time or in a specific sequence.

According to some examples, the method includes receiving a request from a proxy in the network environment at block 202. For example, the DLP scanner 114 illustrated in FIG. 1 may receive a request from a proxy in the network environment. The request asks permission from a server to send content for DLP scanning. The request includes HTTP headers and the content for DLP scanning that are transmitted in a body of the request that are associated with a communication. These HTTP headers contain metadata specifying the sender's identity and the content's destination. The proxy populates these HTTP headers, configured to include the sender's identification information, such as location, department, or role, based on data imported from an active directory. Additionally, the proxy populates the headers with destination information related to where the sender intends to transmit the content.

According to some examples, the method includes performing a policy evaluation at a DLP scanner using information extracted from the HTTP headers included in the request to determine whether the content matches a DLP policy and should undergo scanning at block 204. For example, DLP scanner 114, illustrated in FIG. 1, may perform a policy evaluation using information extracted from the HTTP headers included in the request to determine whether the content matches a DLP policy and should undergo scanning. The DLP scanner receives the DLP policy from an S3 bucket. Configuring the DLP policy at the DLP scanner involves a network administrator using a secure access dashboard associated with the network environment.

In an example, the HTTP header can contain specific details such as user identities and data destinations. Proxy 112 can identify the user and their identity, as well as determine the destination of the data. Proxy 112 transmits this information along with other relevant details, including the original context of the data. For example, when a user uploads data to Dropbox via an HTTP request from a browser, the browser includes its own set of HTTP headers specific to Dropbox. For example, as it pertains to policy evaluation 116, the HTTP header can include the identities, data destination, and potentially the file or data types to be scanned.

In some examples, the DLP policy can be customized by the network administrator and stored in a database. The DLP scanner receives the DLP policy by having the configured policy pushed from the database to the DLP scanner.

According to some examples, the method includes, upon determining the content to undergo scanning in accordance with the DLP policy, sending an HTTP response “100 continue” from the DLP scanner to the proxy at block 206. For example, DLP scanner 114 illustrated in FIG. 1 may, upon determining that the content is to undergo scanning according to the DLP policy, send an HTTP “100 Continue” response from the DLP scanner to the proxy. Conversely, if the content does not require scanning, the DLP scanner replies with an HTTP “200 OK” response to the proxy, indicating that no scan of the content is needed.

According to some examples, the method includes, after sending the HTTP response, receiving the content associated with the request from the proxy for scanning at block 208. For example, the DLP scanner 114 illustrated in FIG. 1 may, after sending in the HTTP response, receive the content associated with the request from the proxy for scanning.

According to some examples, the method includes processing the content scanned at the DLP scanner to identify policy violations at block 210. For example, DLP scanner 114, illustrated in FIG. 1, may process the scanned content to identify policy violations. This processing involves identifying one or more data leak policies within the DLP policy, configured to help the DLP scanner determine whether the content matches a DLP policy. The determining comprises identifying a sender of the content as a member of a specific department based on information extracted from the HTTP headers. The determining comprises determining a destination of the content from the HTTP header information, where the destination may include a network application. The determining comprises matching the information associated with the sender and the destination against the data leak policies to assess if the content requires scanning. Upon determining that an identification of the sender and the destination matches the network application specified in the data leak policies, the DLP scanner performs a scan to check for personally identifiable information (PII) or restricted information that may violate the DLP policy.

According to some examples, the method includes forwarding the content scanned to an intended destination within the network environment when the content is not in violation of the DLP policy at block 212. For example, the DLP scanner 114 illustrated in FIG. 1 may forward the content scanned to an intended destination within the network environment when the content is not in violation of the DLP policy.

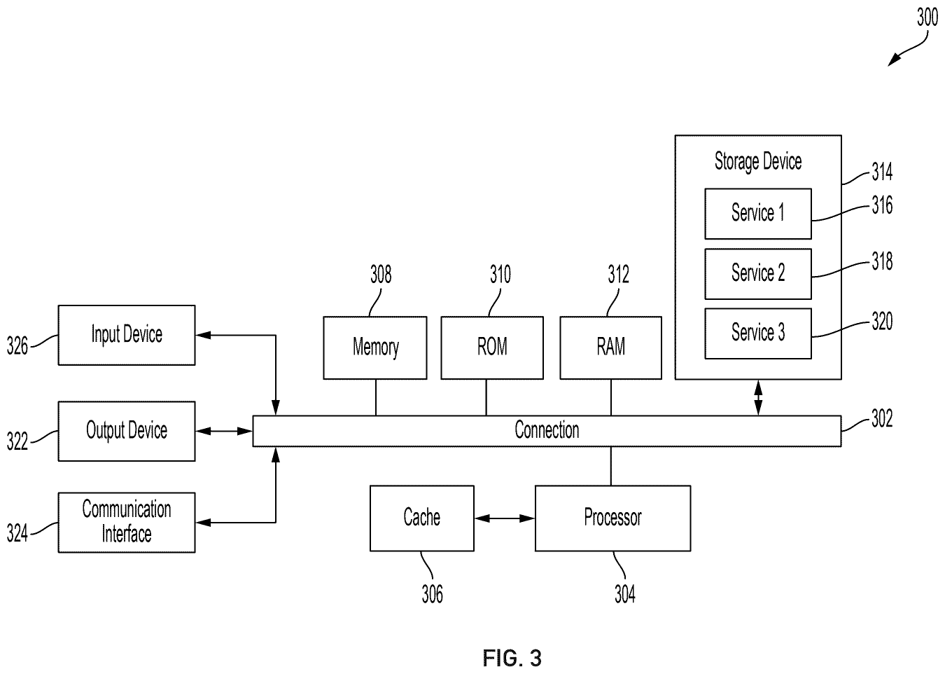

FIG. 3 shows an example of computing system 300, which can be for example any computing device making up a system network, or any component thereof in which the components of the system are in communication with each other using connection 302. Connection 302 can be a physical connection via a bus, or a direct connection into processor 304, such as in a chipset architecture. Connection 302 can also be a virtual connection, networked connection, or logical connection.

In some embodiments, computing system 300 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 300 includes at least one processing unit (central processing unit (CPU) or processor 304) and connection 302 that couples various system components including memory 308, such as read-only memory (ROM) 310 and random access memory (RAM) 312 to processor 304. Computing system 300 can include a cache 306 of a memory 308, such as a high-speed memory, connected directly with, in close proximity to, or integrated as part of processor 304.

Processor 304 can include any general-purpose processor and a hardware service or software service, such as services 316, 318, and 320 stored in storage device 314, configured to control processor 304, as well as a special-purpose processor where software instructions are incorporated into the actual processor design. Processor 304 may essentially be a completely self-contained computing system, containing multiple cores or processors, a bus, memory controller, cache 306, etc. A multi-core processor may be symmetric or asymmetric.

To enable user interaction, computing system 300 includes an input device 326, which can represent any number of input mechanisms, such as a microphone for speech, a touch-sensitive screen for gesture or graphical input, keyboard, mouse, motion input, speech, etc. Computing system 300 can also include output device 322, which can be one or more of a number of output mechanisms known to those of skill in the art. In some instances, multimodal systems can enable a user to provide multiple types of input/output to communicate with computing system 300. Computing system 300 can include communication interface 324, which can generally govern and manage the user input and system output. There is no restriction on operating on any particular hardware arrangement, and therefore the basic features here may easily be substituted for improved hardware or firmware arrangements as they are developed.

Storage device 314 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 314 can include software services, servers, services, etc., that when the code that defines such software is executed by the processor 304, it causes the system to perform a function. In some embodiments, a hardware service that performs a particular function can include the software component stored in a computer-readable medium in connection with the hardware components, such as processor 304, connection 302, output device 322, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Some aspects of the present technology include:

Clause 1. A method for data loss prevention (DLP) scanning in a network environment, comprising: receiving a request from a proxy in the network environment, wherein the request is to ask permission from a server to send content associated with the request for DLP scanning, the request includes HTTP headers and the content for DLP scanning that are transmitted in a body of the request that are associated with a communication; performing a policy evaluation at a DLP scanner using information extracted from the HTTP headers included in the request to determine whether the content matches a DLP policy and should undergo scanning; upon determining the content is to undergo scanning in accordance with the DLP policy, sending an HTTP response “100 continue” from the DLP scanner to the proxy; after sending the HTTP response, receiving the content associated with the request from the proxy for scanning; processing the content scanned at the DLP scanner to identify policy violations; and forwarding the content scanned to an intended destination within the network environment when the content is not in violation of the policy.

Clause 2. The method of clause 1, further comprising: upon determining the content does not necessitate scanning, replying with an HTTP response “200 OK” from the DLP scanner to the proxy, indicating that no scan of the content is required.

Clause 3. The method of clause 1, further comprising receiving the DLP policy at the DLP scanner from an S3 bucket.

Clause 4. The method of clause 3, wherein receiving the DLP policy at the DLP scanner includes: configuring the DLP policy via a secure access dashboard associated with the network environment by a network administrator, wherein the DLP policy configured is stored in a database; and pushing the DLP policy configured to the DLP scanner from the database.

Clause 5. The method of clause 1, wherein the HTTP headers in the body of the request includes: metadata specifying an identity of a sender and a destination of the content.

Clause 6. The method of clause 1, wherein processing the content scanned at the DLP scanner to identify policy violations comprises: identifying one or more data leak policies in the DLP policy, the one or more data leak policies configured to assist the DLP scanner with determining whether the content matches a DLP policy, the determining comprising; identifying a sender of the content scanned as a member of a specific department based on the information extracted from the HTTP headers; determining a destination of the content from the information extracted from the HTTP headers, wherein the destination of the content includes a network application; matching the information associated with the sender and destination against the one or more data leak policies to identify whether the content requires scanning; and in response to determining that an identification of the sender and the destination matches the network application specified in the one or more data leak policies, performing a scan of the content to check for personal identifying information (PII) or restricted information in violation of the DLP policy.

Clause 7. The method of clause 1, wherein the HTTP headers are populated by the proxy, the proxy configured to: populate the HTTP headers with identification information of a sender of the request, including location, department, or role, based on information imported from an active directory; and populate the HTTP headers with destination information related to a destination to which the sender intends to transmit the content.

Clause 8. A network device comprising: one or more memories having computer-readable instructions stored therein; and one or more processors configured to execute the computer-readable instructions to: receive a request from a proxy in a network environment, wherein the request is to ask permission from a server to send content associated with the request for DLP scanning, the request includes HTTP headers that are transmitted in a body of the request, the body of the request comprising the content for DLP scanning; perform a policy evaluation at a DLP scanner using information extracted from the HTTP headers included in the request to determine whether the content matches a DLP policy and should undergo scanning; upon determining the content is to undergo scanning in accordance with the DLP policy, send an HTTP response “100 continue” from the DLP scanner to the proxy; after receiving the HTTP response, receive the content associated with the request from the proxy for scanning; process the content scanned at the DLP scanner to identify policy violations; and forward the content scanned to an intended destination within the network environment when the content is not in violation of the DLP policy.

Clause 9. The network device of clause 8, further comprising: upon determining the content does not necessitate scanning, replying with an HTTP response “200 OK” from the DLP scanner to the proxy, indicating that no scan of the content is required.

Clause 10. The network device of clause 8, further comprising receiving the DLP policy at the DLP scanner from an S3 bucket.

Clause 11. The network device of clause 8, wherein receiving the DLP policy at the DLP scanner includes: configuring the DLP policy via a secure access dashboard associated with the network environment by a network administrator, wherein the DLP policy configured is stored in a database; and pushing the DLP policy configured to the DLP scanner from the database.

Clause 12. The network device of clause 8, wherein the HTTP headers in the body of the request includes: metadata specifying an identity of a sender and a destination of the content.

Clause 13. The network device of clause 8, wherein processing the content scanned at the DLP scanner to identify policy violations comprises: identifying one or more data leak policies in the DLP policy, the one or more data leak policies configured to assist the DLP scanner with determining whether the content matches a DLP policy, the determining comprising: identifying a sender of the content scanned as a member of a specific department based on the information extracted from the HTTP headers; determining a destination of the content from the information extracted from the HTTP headers, wherein the destination of the content includes a network application; matching the information associated with the sender and destination against the one or more data leak policies to identify whether the content requires scanning; and in response to determining that an identification of the sender and the destination matches the network application specified in the one or more data leak policies, performing a scan of the content to check for personal identifying information (PII) or restricted information in violation of the DLP policy.

Clause 14. The network device of clause 8, wherein the HTTP headers are populated by the proxy, the proxy configured to: populate the HTTP headers with identification information of a sender of the request, including location, department, or role, based on information imported from an active directory; and populate the HTTP headers with destination information related to a destination to which the sender intends to transmit the content.

Clause 15. A non-transitory computer-readable storage medium comprising computer-readable instructions, which when executed by one or more processors of a network appliance, cause the network appliance to: receiving a request from a proxy in a network environment, wherein the request is to ask permission from a server to send content associated with the request for DLP scanning, the request includes HTTP headers and the content for DLP scanning that are transmitted in a body of the request that are associated with a communication; performing a policy evaluation at a DLP scanner using information extracted from the HTTP headers included in the request to determine whether the content matches a DLP policy and should undergo scanning; upon determining the content is to undergo scanning in accordance with the DLP policy, sending an HTTP response “100 continue” from the DLP scanner to the proxy; after receiving the HTTP response, receiving the content associated with the request from the proxy for scanning; processing the content scanned at the DLP scanner to identify policy violations; and forwarding the content scanned to an intended destination within the network environment when the content is not in violation of the DLP policy.

Clause 16. The non-transitory computer-readable storage medium of clause 15, wherein the one or more processors further cause the network appliance to: upon determining the content does not necessitate scanning, replying with an HTTP response “200 OK” from the DLP scanner to the proxy, indicating that no scan of the content is required.

Clause 17. The non-transitory computer-readable storage medium of clause 15, wherein the one or more processors further cause the network appliance to: receive the DLP policy at the DLP scanner from an S3 bucket.

Clause 18. The non-transitory computer-readable storage medium of clause 17, wherein receiving the DLP policy at the DLP scanner includes: configuring the DLP policy via a secure access dashboard associated with the network environment by a network administrator, wherein the DLP policy configured is stored in a database; and pushing the DLP policy configured to the DLP scanner from the database.

Clause 19. The non-transitory computer-readable storage medium of clause 17, wherein the HTTP headers in the body of the request includes: metadata specifying an identity of a sender and a destination of the content.

Clause 20. The non-transitory computer-readable storage medium of clause 17, wherein processing the content scanned at the DLP scanner to identify policy violations comprises: identifying one or more data leak policies in the DLP policy, the one or more data leak policies configured to assist the DLP scanner with determining whether the content matches a DLP policy; identifying a sender of the content scanned as a member of a specific department based on the information extracted from the HTTP headers; determining a destination of the content from the information extracted from the HTTP headers, wherein the destination of the content includes a network application; matching the information associated with the sender and destination against the one or more data leak policies to identify whether the content requires scanning; and in response to determining that an identification of the sender and the destination matches the network application specified in the one or more data leak policies, performing a scan of the content to check for personal identifying information (PII) or restricted information in violation of the DLP policy.

Clause 21. The non-transitory computer-readable storage medium of clause 17, wherein the HTTP headers are populated by the proxy, the proxy configured to: populate the HTTP headers with identification information of a sender of the request, including location, department, or role, based on information imported from an active directory; and populate the HTTP headers with destination information related to a destination to which the sender intends to transmit the content.

What is claimed is:

1. A method for data loss prevention (DLP) scanning in a network environment, comprising:
receiving a request from a proxy in the network environment, wherein the request is to ask permission from a server to send content associated with the request for DLP scanning, the request includes HTTP headers and the content for DLP scanning that are transmitted in a body of the request that are associated with a communication;
performing a policy evaluation at a DLP scanner using information extracted from the HTTP headers included in the request to determine whether the content matches a DLP policy and should undergo scanning;
upon determining the content is to undergo scanning in accordance with the DLP policy, sending an HTTP response “100 continue” from the DLP scanner to the proxy;
after sending the HTTP response, receiving the content associated with the request from the proxy for the DLP scanning;
processing the content scanned at the DLP scanner to identify policy violations; and
forwarding the content scanned to an intended destination within the network environment when the content is not in violation of the DLP policy.

2. The method of claim 1, further comprising:
upon determining the content does not necessitate scanning, replying with an HTTP response “200 OK” from the DLP scanner to the proxy, indicating that no scan of the content is required.

3. The method of claim 1, further comprising receiving the DLP policy at the DLP scanner from an S3 bucket.

4. The method of claim 3, wherein receiving the DLP policy at the DLP scanner includes:
configuring the DLP policy via a secure access dashboard associated with the network environment by a network administrator, wherein the DLP policy is stored in a database; and
pushing the DLP policy to the DLP scanner from the database.

5. The method of claim 1, wherein the HTTP headers in the body of the request includes:
metadata specifying an identity of a sender and a destination of the content.

6. The method of claim 1, wherein processing the content scanned at the DLP scanner to identify policy violations comprises:
identifying one or more data leak policies in the DLP policy, the one or more data leak policies configured to assist the DLP scanner with determining whether the content matches the DLP policy, wherein determining comprises:
identifying a sender of the content scanned as a member of a specific department based on the information extracted from the HTTP headers;
determining a destination of the content from the information extracted from the HTTP headers, wherein the destination of the content includes a network application;
matching the information associated with the sender and destination against the one or more data leak policies to identify whether the content requires scanning; and
in response to determining that an identification of the sender and the destination matches the network application specified in the one or more data leak policies, performing a scan of the content to check for personal identifying information (PII) or restricted information in violation of the DLP policy.

7. The method of claim 1, wherein the HTTP headers are populated by the proxy, the proxy configured to:
populate the HTTP headers with identification information of a sender of the request, including location, department, or role, based on information imported from an active directory; and
populate the HTTP headers with destination information related to a destination to which the sender intends to transmit the content.

8. A network device comprising:
one or more memories having computer-readable instructions stored therein;
one or more processors configured to execute the computer-readable instructions to:
receive a request from a proxy in a network environment, wherein the request is to ask permission from a server to send content associated with the request for DLP scanning, the request includes HTTP headers and the content for DLP scanning that are transmitted in a body of the request that are associated with a communication;
perform a policy evaluation at a DLP scanner using information extracted from the HTTP headers included in the request to determine whether the content matches a DLP policy and should undergo scanning;
upon determining the content is to undergo scanning in accordance with the DLP policy, send an HTTP response “100 continue” from the DLP scanner to the proxy;
after sending the HTTP response, receive the content associated with the request from the proxy for scanning;
process the content scanned at the DLP scanner to identify policy violations; and
forward the content scanned to an intended destination within the network environment when the content is not in violation of the DLP policy.

9. The network device of claim 8, further comprising:
upon determining the content does not necessitate scanning, replying with an HTTP response “200 OK” from the DLP scanner to the proxy, indicating that no scan of the content is required.

10. The network device of claim 8, further comprising receiving the DLP policy at the DLP scanner from an S3 bucket.

11. The network device of claim 8, wherein receiving the DLP policy at the DLP scanner includes:
configuring the DLP policy via a secure access dashboard associated with the network environment by a network administrator, wherein the DLP policy configured is stored in a database; and
pushing the DLP policy configured to the DLP scanner from the database.

12. The network device of claim 8, wherein the HTTP headers in the body of the request includes:
metadata specifying an identity of a sender and a destination of the content.

13. The network device of claim 8, wherein processing the content scanned at the DLP scanner to identify policy violations comprises:
identifying one or more data leak policies in the DLP policy, the one or more data leak policies configured to assist the DLP scanner with determining whether the content matches a DLP policy, wherein determining comprises:
identifying a sender of the content scanned as a member of a specific department based on the information extracted from the HTTP headers;
determining a destination of the content from the information extracted from the HTTP headers, wherein the destination of the content includes a network application;
matching the information associated with the sender and destination against the one or more data leak policies to identify whether the content requires scanning; and
in response to determining that an identification of the sender and the destination matches the network application specified in the one or more data leak policies, performing a scan of the content to check for personal identifying information (PII) or restricted information in violation of the DLP policy.

14. The network device of claim 8, wherein the HTTP headers are populated by the proxy, the proxy configured to:
populate the HTTP headers with identification information of a sender of the request, including location, department, or role, based on information imported from an active directory; and
populate the HTTP headers with destination information related to a destination to which the sender intends to transmit the content.

15. A non-transitory computer-readable storage medium comprising computer-readable instructions, which when executed by one or more processors of a network appliance, cause the network appliance to:
receiving a request from a proxy in a network environment, wherein the request is to ask permission from a server to send content associated with the request for DLP scanning, the request includes HTTP headers and the content for DLP scanning that are transmitted in a body of the request that are associated with a communication;
performing a policy evaluation at a DLP scanner using information extracted from the HTTP headers included in the request to determine whether the content matches a DLP policy and should undergo scanning;
upon determining the content is to undergo scanning in accordance with the DLP policy, sending an HTTP response “100 continue” from the DLP scanner to the proxy;
after sending the HTTP response, receiving the content associated with the request from the proxy for scanning;
processing the content scanned at the DLP scanner to identify policy violations; and
forwarding the content scanned to an intended destination within the network environment when the content is not in violation of the DLP policy.

16. The non-transitory computer-readable storage medium of claim 15, wherein the one or more processors further cause the network appliance to:
upon determining the content does not necessitate scanning, replying with an HTTP response “200 OK” from the DLP scanner to the proxy, indicating that no scan of the content is required.

17. The non-transitory computer-readable storage medium of claim 15, wherein the one or more processors further cause the network appliance to:
receive the DLP policy at the DLP scanner from an S3 bucket.

18. The non-transitory computer-readable storage medium of claim 17, wherein receiving the DLP policy at the DLP scanner includes:
configuring the DLP policy via a secure access dashboard associated with the network environment by a network administrator, wherein the DLP policy configured is stored in a database; and
pushing the DLP policy configured to the DLP scanner from the database.

19. The non-transitory computer-readable storage medium of claim 17, wherein the HTTP headers in the body of the request includes:
metadata specifying an identity of a sender and a destination of the content.

20. The non-transitory computer-readable storage medium of claim 17, wherein processing the content scanned at the DLP scanner to identify policy violations comprises:
identifying one or more data leak policies in the DLP policy, the one or more data leak policies configured to assist the DLP scanner with determining whether the content matches a DLP policy, wherein determining comprises:
identifying a sender of the content scanned as a member of a specific department based on the information extracted from the HTTP headers;
determining a destination of the content from the information extracted from the HTTP headers, wherein the destination of the content includes a network application;
matching the information associated with the sender and destination against the one or more data leak policies to identify whether the content requires scanning; and
in response to determining that an identification of the sender and the destination matches the network application specified in the one or more data leak policies, performing a scan of the content to check for personal identifying information (PII) or restricted information in violation of the DLP policy.
